(19) United States
(12) Patent Application Publication
(10) Pub. No.: US 2012/0296571 A1
(43) Pub. Date: Nov. 22, 2012

(54) ORGANISM INFORMATION MEASURING INSTRUMENT, PORTABLE TERMINAL DEVICE, ORGANISM INFORMATION MEASURING METHOD, AND PROGRAM

(75) Inventors: Shigeki Shinoda, Tokyo (JP); Yasuhiro Sasaki, Tokyo (JP); Hiroshi Sakai, Tokyo (JP); Masatake Takahashi, Tokyo (JP)

(73) Assignee: NEC CORPORATION, Tokyo (JP)

(21) Appl. No.: 13/576,769

(22) PCT Filed: Jan. 4, 2011
(86) PCT No.: PCT/JP2011/050004

§ 371 Date: Aug. 2, 2012

(30) Foreign Application Priority Data
Feb. 5, 2010 (JP) 2010-024456

(51) Int. Cl. G06F 19/00

(52) U.S. Cl. 702/19

(57) ABSTRACT

An organism information measuring instrument of the present invention includes: a sensor that measures organism information; a normalization circuit that normalizes the organism information by converting a value of the organism information based on preset normalization information; and a reliability information generation circuit that detects a change amount greater than or equal to a predetermined value in a predetermined time period, with respect to the organism information or the normalized organism information, and generates reliability information indicating lower reliability as the change amount is greater.

### TECHNICAL FIELD

The present invention relates to an organism information measuring instrument, a portable terminal device, an organism information measuring method, and a program.

### BACKGROUND ART

There have been proposed some services which determine and provide an abstract state such as a health state of a person subject to measurement by measuring organism information such as a heart rate and a respiration rate. For example, Patent Document 1 discloses a portable information terminal apparatus that estimates a health state of a person subject to measurement from data of an electrocardiogram and a heart rate and providing an urgent message when it is determined that the person subject to measurement has fallen into a state of emergency. Patent Document 2 discloses an organism information monitoring system that estimates a health state of a person subject to measurement from a body temperature, a pulse, and a blood pressure and estimates a risk of a stroke or a myocardial infarction based on the difference of body temperatures, pulses, and blood pressures at a left side and a right side of a body.

When organism information is measured using a contact-type sensor, a measurement error may be generated due to detachment of a sensor terminal. For this reason, it becomes important to determine whether measurement is accurately performed. For example, Patent Document 3 discloses a method of determining that a body of a person subject to measurement contacts a detecting unit when a current between electrodes is detected and a method of determining that the body of a person subject to measurement contacts the detecting unit when a heart rate or a blood pressure is within a predetermined range, in an information communication terminal that measures information of a human body. Patent Document 4 discloses a method of determining that a measurement error is generated when measurement is performed a plurality of times and the difference of a first measurement value and a second measurement value is too large, in a blood pressure measuring device.

### PRIOR ART DOCUMENTS

### Patent Documents

[Patent Document 1] Japanese Unexamined Patent Application Publication, First Publication No. 2008-229092
[Patent Document 2] Japanese Patent Publication No. 3843118
[Patent Document 3] Japanese Unexamined Patent Application, First Publication No. 2005-287691
[Patent Document 4] Japanese Unexamined Patent Application, First Publication No. 2008-279185

### SUMMARY OF THE INVENTION

### Problem to be Solved by the Invention

When the methods described above are used, a certain measurement value is obtained. However, when the measurement error is actually generated, the health state or the like may not be appropriately determined.

For example, when the sensor terminal is partially detached, the measurement value of the sensor does not become 0 and only organism information having a small measurement value is measured. In this case, in the method disclosed in Patent Document 3 using the detection of the current, due to portion of the sensor contacting the human body, the current may be detected and the measurement error may not be detected. In the method disclosed in Patent Document 3 using the determination on whether the heart rate or the blood pressure is within the predetermined range, when a measurement value after the partial detachment of the sensor terminal is within the predetermined range, the measurement error cannot be detected. In the method disclosed in Patent Document 4 using the difference between the first measurement value and the second measurement value, when the difference between the measurement values is not large before and after the partial detachment of the sensor terminal, the measurement error cannot be detected. In particular, when a value of the organism information increases such as when a perspiration amount during exercise is measured, the difference between the measurement values tends to not become large before and after the partial detachment of the sensor terminal.

Accordingly, when these error determining methods are used to determine the health state, a certain measurement value is obtained. However, when the measurement error is actually generated, the health state may not be appropriately determined.

The present invention has been made in view of the above-described circumstances. One exemplary object of the present invention is to provide an organism information measuring instrument, an organism information measuring method, and a program that can measure organism information more appropriately even when a constant measurement value is obtained but a measurement error is actually generated, and a portable terminal device that can more appropriately determine a state of an person subject to measurement based on the organism information.

### Means for Solving the Problem

[1] The present invention has been conceived in order to solve the above-described problems. An organism information measuring instrument according to one exemplary aspect of the present invention, includes: a sensor that measures organism information; a normalization circuit that normalizes the organism information by converting a value of the organism information based on preset normalization information; and a reliability information generation circuit that detects a change amount greater than or equal to a predetermined value in a predetermined time period, with respect to the organism information or the normalized organism information, and generates reliability information indicating lower reliability as the change amount is greater.

[2] The above organism information measuring instrument may include a plurality of the sensors; a plurality of the normalization circuits that normalize the organism information measured by each of the sensors; a plurality of the reliability information generation circuits that generate the reliability information for each of the organism information or each of the normalized organism information; and a weighted averaging circuit that performs weighted averaging on pieces of the normalized organism information with larger weight for the organism information having higher reliability based on the reliability information.

[3] In the above organism information measuring instrument, the organism information measuring instrument may include a plurality of types of the sensors and measure a plurality of types of the organism information, and the weighted averaging circuit may calculate a weighted average of the plurality of types of normalized organism information.

[4] In the above organism information measuring instrument, the reliability information generation circuits may determine an increase/decrease of values of the organism information measured by the plurality of sensors, the reliability information generation circuits may generate the reliability information indicating higher reliability in a case where all the values of the organism information increase or do not change and in a case where all the values of the organism information decrease or do not change, and the reliability information generation circuits may generate the reliability information indicating lower reliability in a case where the value of one organism information increases and the value of another organism information decreases.

[5] A portable terminal device according to one exemplary aspect of the present invention includes the above organism information measuring instrument, the plurality of types of sensors include a perspiration sensor, which measures a perspiration amount and a heartbeat sensor which measures a heart rate, the weighted averaging circuit calculates a weighted average of the plurality of types of normalized organism information including the normalized perspiration amount and the normalized heart rate, and the portable terminal device includes: an exercise load determination circuit that determines an exercise load of an person subject to measurement based on the weighted average; and a display circuit that displays the determined exercise load.

[6] A portable terminal device according to one exemplary aspect of the present invention includes the above organism information measuring instrument, the organism information measuring instrument includes: a plurality of the sensors; a plurality of normalization circuits that normalize the organism information measured by each of the sensors, and a plurality of the reliability information generation circuits that generate the reliability information for each of the organism information or each of the normalized organism information, and the plurality of the sensors include a perspiration sensor which measures a perspiration amount and a body temperature sensor which measures a body temperature, and the portable terminal device includes: a mental state determination circuit that determines a mental state of an person subject to measurement based on the perspiration amount and reliability information of the perspiration amount and the body temperature and reliability information of the body temperature; and a display circuit that displays the determined mental state.

[7] The above portable terminal device includes: a transmission circuit that transmits mental state information indicating the mental state determined by the mental state determination circuit to another terminal device.

[8] An organism information measuring method according to one exemplary aspect of the present invention includes: a measuring step of measuring organism information; a normalizing step of normalizing each of the organism information by converting a value of the organism information based on preset normalization information; and a reliability information generating step of detecting a change amount greater than or equal to a predetermined value in a predetermined time period, with respect to the organism information or the normalized organism information, and generating reliability information indicating lower reliability as the change amount is greater.

[9] A program according to one exemplary aspect of the present invention causes a computer to execute: a measuring step of measuring organism information; a normalizing step of normalizing each of the organism information by converting a value of the organism information based on preset normalization information; and a reliability information generating step of detecting a change amount greater than or equal to a predetermined value in a predetermined time period, with respect to the organism information or the normalized organism information, and generating reliability information indicating lower reliability as the change amount is greater.

### Effect of the Invention

According to the present invention, even when a constant measurement value is obtained but a measurement error is actually generated, organism information can be more appropriately measured and a state of an person subject to measurement can be more appropriately determined based on the organism information.

### BRIEF DESCRIPTION OF THE DRAWINGS

FIG. 1 is a configuration diagram showing a schematic configuration of a portable phone according to a first exemplary embodiment of the present invention.

FIG. 2A is an external view showing an external shape of the portable phone according to the same exemplary embodiment.

FIG. 2B is an external view showing an external shape of the portable phone according to the same exemplary embodiment.

FIG. 2C is a cross-sectional view showing a cross-section of the portable phone according to the same exemplary embodiment.

FIG. 3A is a diagram showing an example of a conversion function of converting a current value into a perspiration amount by a normalization circuit in the same exemplary embodiment.

FIG. 3B is a diagram showing an example of a conversion function of converting a current value into a perspiration amount by the normalization circuit in the same exemplary embodiment.

FIG. 3C is a diagram showing an example of a conversion function of converting a current value into a perspiration amount by the normalization circuit in the same exemplary embodiment.

FIG. 4A is a diagram showing an example of reliability information when the perspiration amount is measured normally in the same exemplary embodiment.

FIG. 4B is a diagram showing the example of reliability information when the perspiration amount is measured normally in the same exemplary embodiment.

FIG. 4C is a diagram showing the example of reliability information when the perspiration amount is measured normally in the same exemplary embodiment.

FIG. 5A is a diagram showing an example of reliability information when a sensor terminal is partially detached during measurement of the perspiration amount in the same exemplary embodiment.

FIG. 5B is a diagram showing the example of reliability information when the sensor terminal is partially detached during measurement of the perspiration amount in the same exemplary embodiment.

FIG. 5C is a diagram showing the example of reliability information when the sensor terminal is partially detached during measurement of the perspiration amount in the same exemplary embodiment.

FIG. 6 is a flowchart showing a sequence of processing for measuring organism information of a person subject to measurement, and determining and displaying an exercise load by the portable phone in the same exemplary embodiment.

FIG. 7 is a configuration diagram showing a schematic configuration of a portable phone according to a second exemplary embodiment of the present invention.

FIG. 8 is a configuration diagram showing a schematic configuration of a portable phone according to a third exemplary embodiment of the present invention.

FIG. 9 is a configuration diagram showing a schematic configuration of a portable phone according to a fourth exemplary embodiment of the present invention.

FIG. 10A is an external view showing an external shape of the portable phone according to the same exemplary embodiment.

FIG. 10B is an external view showing an external shape of the portable phone according to the same exemplary embodiment.

FIG. 10C is a cross-sectional view showing a cross-section of the portable phone according to the same exemplary embodiment.

### EMBODIMENTS FOR CARRYING OUT THE INVENTION

### First Exemplary Embodiment

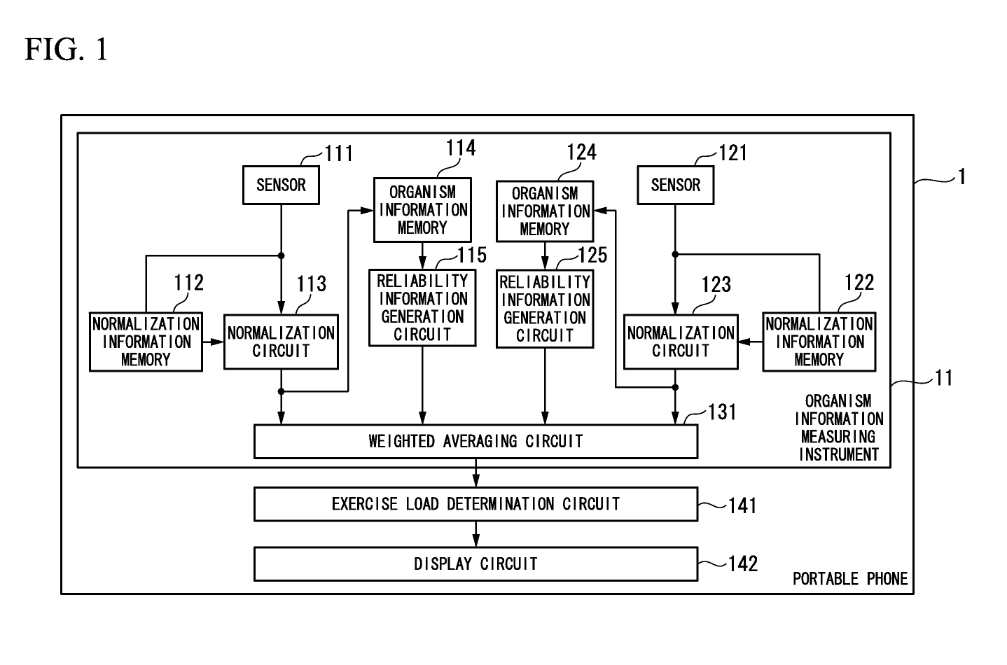

Hereinafter, exemplary embodiments of the present invention will be described with reference to the drawings. FIG. 1 is a configuration diagram showing a schematic configuration of a portable phone (portable terminal device) 1 according to a first exemplary embodiment of the present invention.

In FIG. 1, the portable phone 1 includes an organism information measuring instrument 11, an exercise load determination circuit 141, and a display circuit 142. The organism information measuring instrument 11 includes sensors 111 and 121, normalization information memories 112 and 122, normalization circuits 113 and 123, organism information memories 114 and 124, reliability information generation circuits 115 and 125, and a weighted averaging circuit 131.

The portable phone 1 includes components other than the components shown in FIG. 1, such as a voice processing circuit to convert a voice signal into an electric signal when a person subject to measurement makes a call and a communication circuit to perform a call to another phone.

The organism information measuring instrument 11 measures a perspiration amount of the person subject to measurement (user of the portable phone 1) and generates an index indicating an exercise load (load applied to a body by exercising) of the person subject to measurement based on the measured perspiration amount.

The sensors 111 and 121 are perspiration sensors that measure the perspiration amount of the user and output a current according to the measured perspiration amount.

The normalization circuit 113 calculates the perspiration amount by normalizing a current value output by the sensor 111.

The “normalization” means converting data measured by the sensor into data of units of processing objects. The normalization is described in detail below. The normalization circuit 123 calculates the perspiration amount by normalizing the current value output by the sensor 121. The normalization information memory 112 stores normalization information that is information for performing normalization by the normalization circuit 113. The normalization information memory 122 stores normalization information that is information for performing normalization by the normalization circuit 123.

The organism information memory 114 stores the perspiration amount calculated by the normalization circuit 113, corresponding to a predetermined time. The organism information memory 124 stores the perspiration amount calculated by the normalization circuit 123, corresponding to a predetermined time. The reliability information generation circuit 115 generates reliability information indicating reliability of data measured by the sensor 111 based on the perspiration amount stored in the organism information memory 114. The reliability information generation circuit 125 generates reliability information indicating reliability of data measured by the sensor 121 based on the perspiration amount stored in the organism information memory 124.

The weighted averaging circuit 131 weights the perspiration amounts calculated by the normalization circuits 113 and 123 based on the reliability information generated by the reliability information generation circuits 115 and 125, and calculates an average value of the weighted perspiration amounts.

The exercise load determination circuit 141 determines whether the exercise load of the person subject to measurement is an appropriate load or an excessive load based on the average value of the perspiration amounts calculated by the weighted averaging circuit 131. The display circuit 142 includes a display screen such as a liquid crystal panel and displays the determination result of the exercise load determination circuit 141.

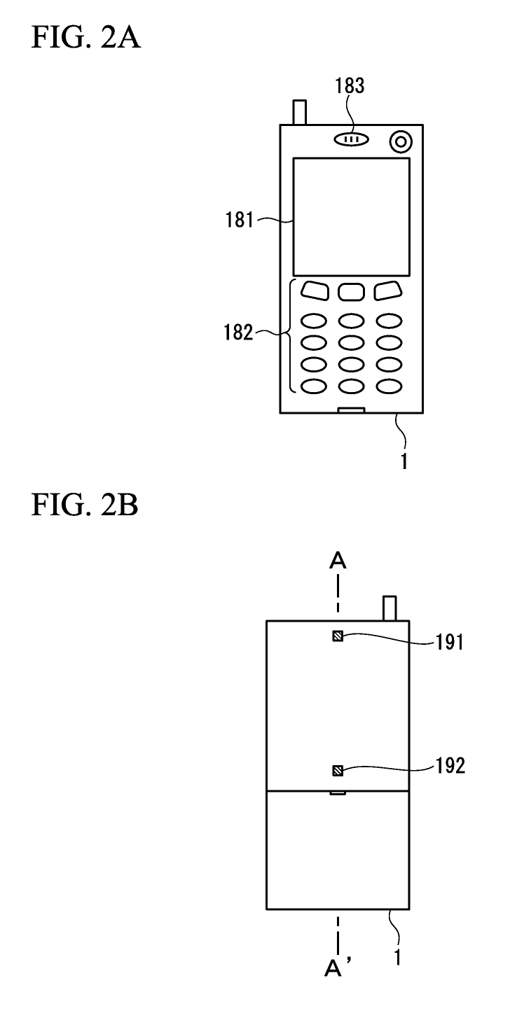

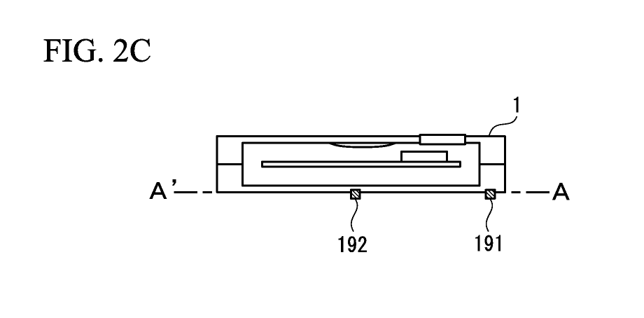

FIGS. 2A and 2B are external views showing an external shape of the portable phone 1. FIG. 2C is a cross-sectional view showing a cross-section of the portable phone 1.

FIG. 2A is an external view of the front side of the portable phone 1. In FIG. 2A, the portable phone 1 includes a display screen 181, an operation button 182, and a speaker 183. The display screen 181 is a display screen such as a liquid crystal panel, and displays the exercise load determined by the exercise load determination circuit 141. The operation button 182 includes a push button such as a numeric keypad and receives an operation input from the person subject to measurement. The speaker 183 outputs a voice such as that of a calling partner.

FIG. 2B is an external view of the back side of the portable phone 1. In FIG. 2B, the portable phone 1 includes sensor terminals 191 and 192. The sensor terminals 191 and 192 are terminals to measure the perspiration amounts by the sensors 111 and 121.

FIG. 2C is a cross-sectional view of the portable phone 1 taken along the line A-A′ of FIG. 2B. As shown in FIG. 2B, the sensor terminals 191 and 192 protrude to a back surface of the portable phone 1. The person subject to measurement holds the portable phone 1 such that the sensor terminals 191 and 192 contact a palm of the person subject to measurement. In this state, if the person subject to measurement sweats, the current that flows through each of the sensors 111 and 121 changes. The sensors 111 and 121 output the currents.

Next, the normalization that is performed by the normalization circuits 113 and 123 will be described.

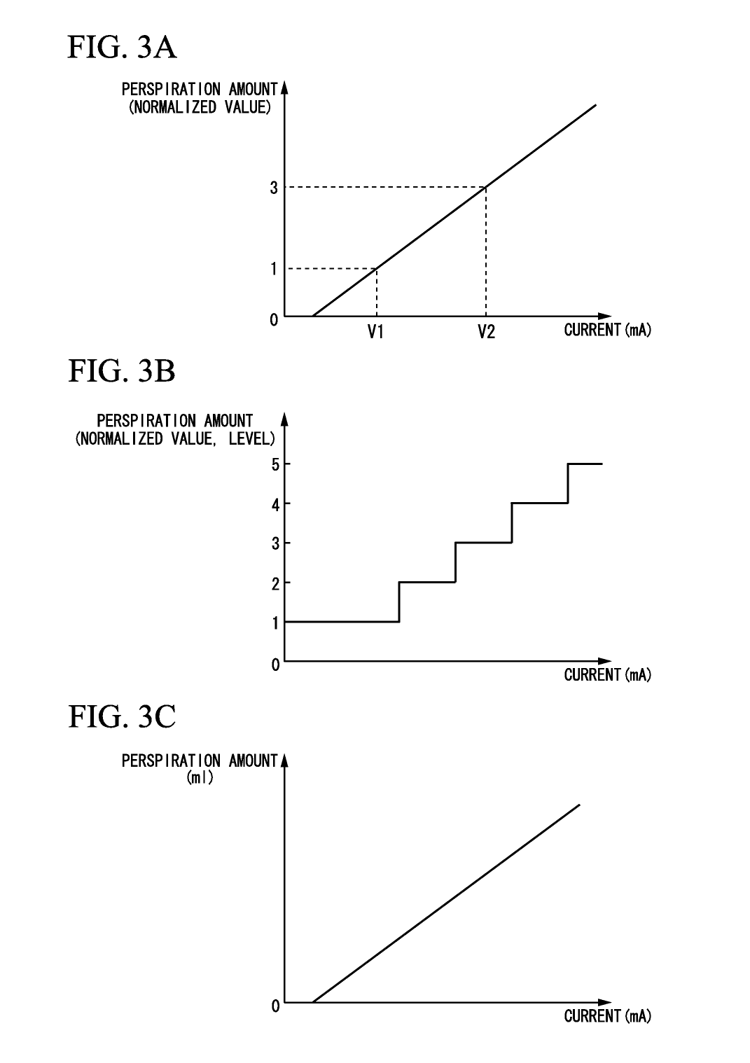

FIGS. 3A to 3C are diagrams showing examples of a conversion function of converting a current value into a perspiration amount by the normalization circuit 113. A horizontal axis of FIGS. 3A to 3C indicates a current value output by the sensor 111. A vertical axis of FIGS. 3A to 3C indicates a perspiration amount calculated by the normalization circuit 113.

Hereinafter, the example of the change function illustrated in FIG. 3A will be described. For example, in the same environment as an environment in which the person subject to measurement exercises, such as an environment in which a room temperature is 20 degrees Celsius, a perspiration amount of the person subject to measurement in the normal case in which the person subject to measurement does not exercise and a perspiration amount of the person subject to measurement when the person subject to measurement performs the exercise of a predetermined load are previously measured. In this case, a conversion function of setting the perspiration amount in the normal case to a reference value “1” of the normalized perspiration amount and setting the perspiration amount in the case of the exercise of the predetermined load to “3” is determined.

Specifically, the normalization information memory 112 previously stores a function according to a characteristic of the sensor 111. This function is a function of outputting the normalized perspiration amount when the current value output by the sensor 111 is input. The function has two parameters that include a parameter indicating an input value in which an output value of the function becomes “1” and a parameter indicating an input value in which an output value of the function becomes “3.” An example of the function is shown by Expression (1).

$$\begin{matrix}[ Expression ( 1 ) ] & \\ {f}_{( x )} = \frac{2}{{x}_{3} - {x}_{1}} ( x - {x}_{1} ) + 1 & ( 1 )\end{matrix}$$

where x₁ is a parameter that indicates a value of x realizing f₍ₓ₎=1, and

x₃ is a parameter that indicates a value of x realizing f₍ₓ₎=3.

In the normal case, if the person subject to measurement performs an operation input to instruct measurement of the perspiration amount in the normal case from the operation button 182, a normalization information generation circuit (not shown in the figure) reads a current value output by the sensor 111 and writes the read current value (measurement value V1 in the normal case) to the parameter indicating the input value in which the output value of the function becomes “1.” In a state of performing the exercise of the predetermined load, if the person subject to measurement performs an operation input to instruct measurement of the perspiration amount when the operator performs the exercise of the predetermined load from the operation button 182, the normalization information generation circuit reads the current value output by the sensor 111 and writes the read current value (measurement value V2 in the case of the exercise of the predetermined load) to the parameter indicating the input value in which the output value of the function becomes “3.” Thereby, a conversion function according to the characteristic of the sensor 111 of setting the perspiration amount in the normal case to “1” and setting the perspiration amount when the operator performs the exercise of the predetermined load to “3” is obtained.

The normalization information memory 112 stores the conversion function. The normalization circuit 113 calculates the normalized perspiration amount based on the conversion function stored in the normalization information memory 112.

Similar to the normalization information memory 112, the normalization information memory 122 has two parameters that include a parameter indicating an input value in which an output value of the function becomes “1” and a parameter indicating an input value in which an output value of the function becomes “3” and previously stores a function according to a characteristic of the sensor 121. When current values output by the sensor 111 are written to the parameters of the function stored in the normalization information memory 112, the normalization information generation circuit 125 reads the current values output by the sensor 121 and writes the read current values (measurement value V1 in the normal case and measurement value V2 in the case of the exercise of the predetermined load) to the parameters of the function stored in the normalization information memory 122. Thereby, a conversion function according to the characteristic of the sensor 121 of setting the perspiration amount in the normal case to “1” and setting the perspiration amount when the operator performs the exercise of the predetermined load to “3” is obtained.

The normalization information memory 122 stores the conversion function. The normalization circuit 123 calculates the normalized perspiration amount based on the conversion function stored in the normalization information memory 122.

By the organism information measuring instrument 11 performing the normalization, it is possible to determine the state of the person subject to measurement from the measurement value regardless of the individual differences between persons subject to measurement. Moreover, regardless of the characteristic variation of each sensor and the difference of units of organism information when a plurality of types of organism information are measured to be described below, measurement values that are obtained by the plurality of sensors can be compared.

That is, when the exercise load is determined from the perspiration amount, even if the perspiration amounts measured by the sensors are the same in a person subject to measurement having a smaller perspiration amount and a person subject to measurement having a larger perspiration amount, the person subject to measurement having the smaller perspiration amount is considered to be performing exercise of a higher load. The normalization circuit 113 calculates the relative perspiration amount based on the perspiration amount of the person subject to measurement in the normal case, instead of calculating the absolute perspiration amount not depending on the person subject to measurement such as calculating the perspiration amount in units of millimeters (ml). For this reason, the exercise load can be appropriately determined according to the characteristic of the person subject to measurement based on the calculated perspiration amount.

The normalization information memories 112 and 122 store the conversion functions according to the characteristics of the sensors 111 and 121, respectively. For this reason, even when the measurement value measured by each sensor is different owing to the characteristic of each sensor, for example, when the sensors 111 and 121 output currents of different values with respect to the same perspiration amount, the perspiration amount can be appropriately calculated according to the characteristic of the sensor.

The conversion functions that are stored in the normalization information memories 112 and 122 and the perspiration amounts that are calculated by the normalization circuits 113 and 123 are not limited to the above example.

For example, as shown in FIG. 3B, the normalization information memories 112 and 122 may store functions for converting current values into perspiration amounts of five steps and the normalization circuits 113 and 123 may calculate levels of five steps indicating the perspiration amounts. For example, the exercise load of the person subject to measurement can be determined based on the level of the perspiration amount; for example, when the perspiration amount is a level 3, it can be determined that the exercise load is a middle level.

The case in which the organism information measuring instrument 11 measures the perspiration amount in units of millimeters will be described with reference to FIG. 3C. In this case, as shown in FIG. 3C, the normalization information memories 112 and 122 store the functions for converting the current values into the perspiration amounts in units of milliliters. The normalization circuits 113 and 123 calculate the perspiration amounts in units of milliliters. In this case, the normalization circuits 113 and 123 perform normalization to calculate the perspiration amounts according to the characteristic variation between the sensors.

Next, reliability information that is calculated by the reliability information generation circuits 115 and 125 will be described.

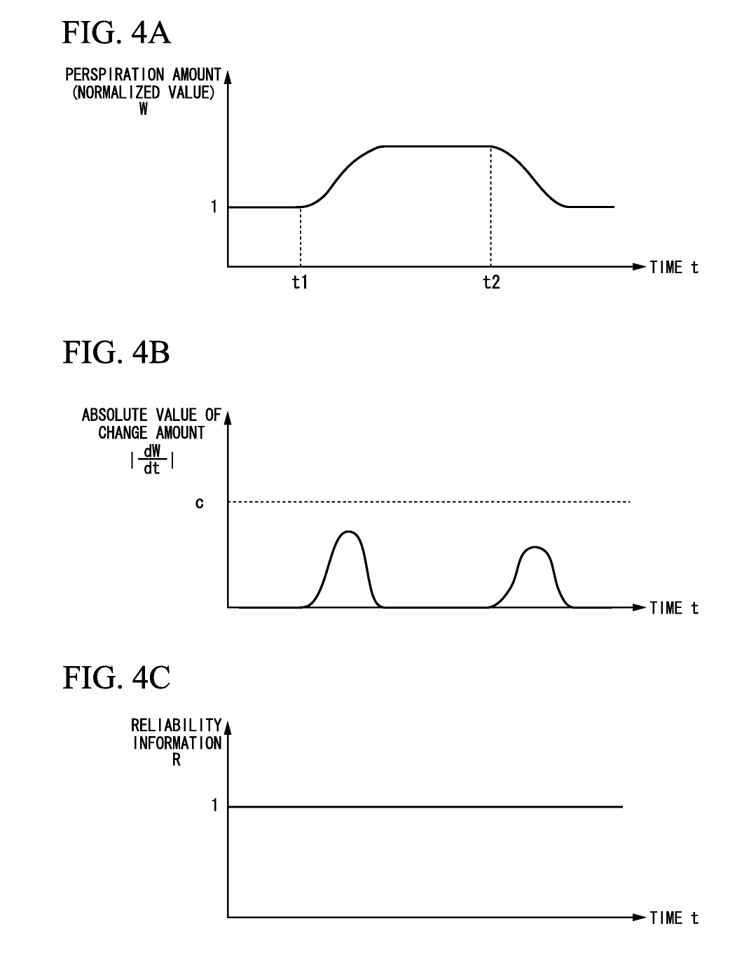

FIGS. 4A to 4C are diagrams showing examples of reliability information when the perspiration amount is measured normally.

FIG. 4A is a diagram showing an example of the perspiration amount calculated by the normalization circuit 113 when the perspiration amount is measured normally. In FIG. 4A, a horizontal axis indicates a time t and a vertical axis indicates a perspiration amount W.

In the example shown in FIG. 4A, the person subject to measurement starts the exercise at a time t1 and terminates the exercise at a time t2. The perspiration amount before starting the exercise is a value “1” in the normal case and the perspiration amount increases after starting the exercise. The perspiration amount after terminating the exercise decreases and returns to the value “1” in the normal case as the time passes.

FIG. 4B is a diagram showing an absolute value |dw/dt| of a change amount of the perspiration amount in FIG. 4A. In FIG. 4B, a horizontal axis indicates a time t and a vertical axis indicates an absolute value |dw/dt| of a change amount of the perspiration amount. A reference value c shown in FIG. 4B is a value that is greater than a maximum value of the absolute value of the change amount of the perspiration amount when the perspiration amount is measured normally.

FIG. 4C is a diagram showing reliability information calculated by the reliability information generation circuit 115 with respect to the perspiration amount of FIG. 4A. In FIG. 4C, a horizontal axis indicates a time t and a vertical axis indicates a value of reliability information R.

The reliability information can be calculated using Expression (2).

$$\begin{matrix}[ Expression ( 2 ) ] & \\ R = \frac{1}{1 + a log ( 1 + \int v d t )} & ( 2 )\end{matrix}$$

where a is a constant.

$$v = \{ \begin{matrix}\vert \frac{d w}{d t} \vert & … & when \vert \frac{d w}{d t} \vert \geq c \\ 0 & … & when \vert \frac{d w}{d t} \vert < c \end{matrix}$$

Expression (2) is a function of calculating an integration of an absolute value of a change amount becoming the reference value c or more, and in which the reliability information R becomes 1 when a calculated value is 0 and the reliability information R decreases as the calculated value increases. As such, weighted averaging can be performed with respect to organism information calculated from the measurement value of each sensor by calculating the reliability information the value which decreases when the perspiration amount rapidly changes and using the reliability information as the weight. If the value of the organism information rapidly changes due to the measurement error by the partial detachment of the sensor terminal, the weight (value of the reliability information) decreases. For this reason, the weighted averaging can be performed by relatively increasing the weight of the organism information in which the measurement error is not detected and the organism information can be accurately calculated.

The reliability information takes a value from 0 to 1 and shows that the reliability of the perspiration amount calculated by the normalization circuit 113 is high when the value is large. As shown in FIG. 4B, when the absolute value of the change amount of the perspiration amount is less than the reference value c, the value of the reliability information is maintained at “1”.

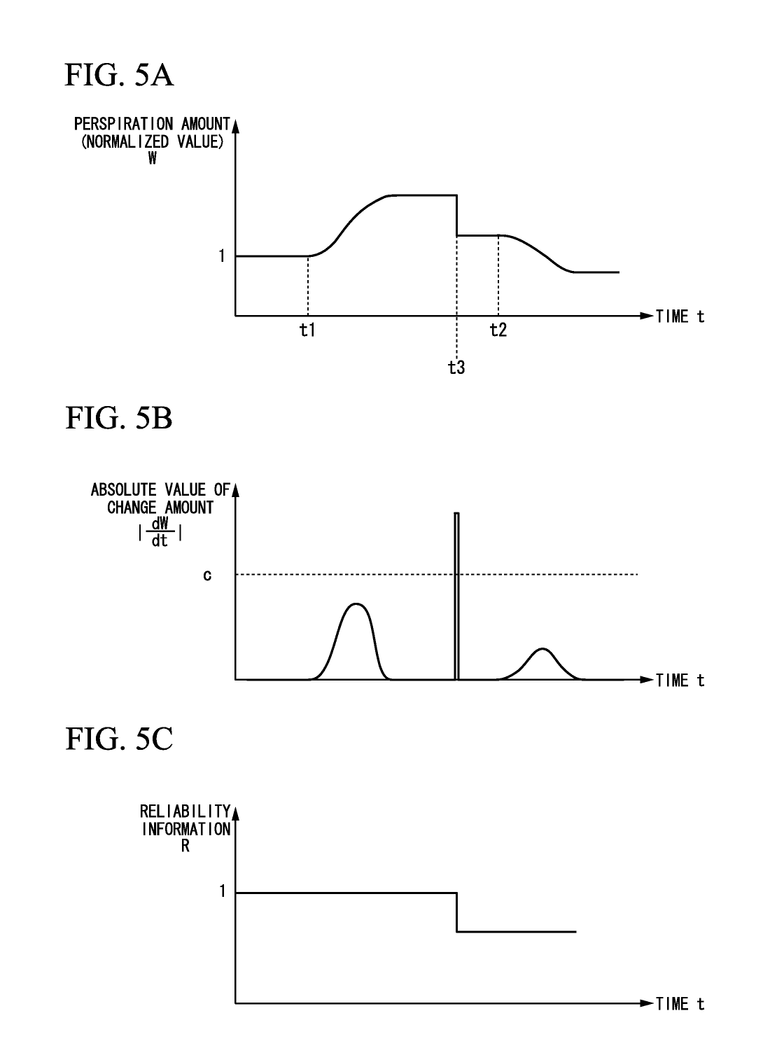

FIGS. 5A to 5C are diagrams showing examples of reliability information when the sensor terminal 191 is partially detached while measuring the perspiration amount.

FIG. 5A is a diagram showing an example of the perspiration amount calculated by the normalization circuit 113 when the sensor terminal 191 is partially detached while measuring the perspiration amount. In the case shown in FIG. 5A, the perspiration amount increases after starting the exercise at a time t1, similar to FIG. 4A. However, at a time t3, the sensor terminal 191 is partially detached and the perspiration amount (calculation value of the normalization circuit 113) decreases. The partial detachment of the sensor terminal 191 is generated, for example, when the portion of the sensor terminal 191 does not contact the palm after a state in which the person subject to measurement holds the portable phone 1 again.

After the partial detachment of the sensor terminal 191, the perspiration amount decreases after terminating the exercise at the time t2 and the sensor terminal is partially detached. For this reason, a state becomes a normal state with the perspiration amount less than the value “1” in the normal case.

FIG. 5B is a diagram showing an absolute value |dW/dt| of a change amount of the perspiration amount in FIG. 5A. When the sensor terminal is partially detached, the perspiration amount changes more rapidly than the change in the perspiration amount by the exercise. For this reason, in the example of FIG. 5B, a change more than the reference value c is shown at the time t3 when the sensor terminal 191 is partially changed.

FIG. 5C is a diagram showing reliability information calculated by the reliability information generation circuit 115 with respect to the perspiration amount of FIG. 5A. Before the state where the sensor terminal is partially detached, the value of the reliability information becomes “1.” Meanwhile, the value of the reliability information becomes a value smaller than “1” after the sensor terminal is partially detached and the absolute value of the change amount of the perspiration amount becomes the reference value c or more, as shown in FIG. 5B.

As shown in FIG. 5B, determining the reference value c and detecting the change amount becoming the reference value c or more corresponds to detecting a change amount greater than or equal to a predetermined value in a predetermined time period. That is, because the reference value c is set in a dimension of perspiration amount/time, it is detected that the change of a specific amount or more has been generated in a specific time period.

Next, an operation of the portable phone 1 will be described.

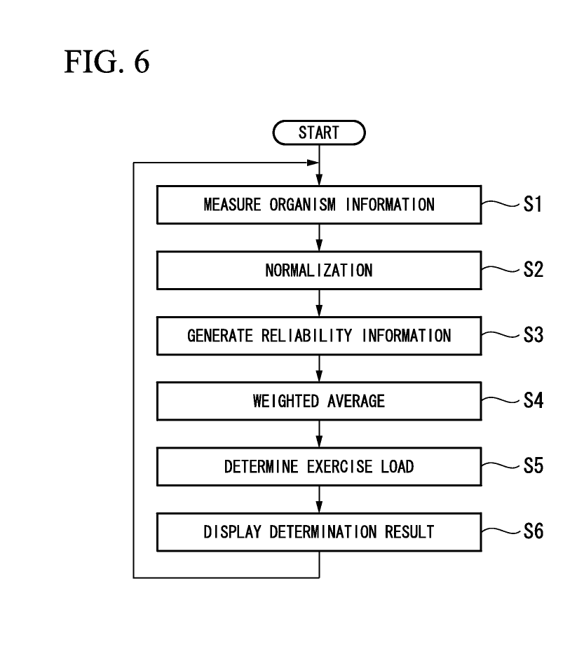

FIG. 6 is a flowchart showing a sequence of processing for measuring organism information of a person subject to measurement, and determining and displaying an exercise load by the portable phone 1. If the person subject to measurement contacts the sensor terminals 191 and 192 with the palm and performs an operation input to instruct the determination of the exercise load from the operation button 182, the portable phone 1 starts the processing of FIG. 6.

First, the sensors 111 and 121 measure the perspiration amounts as the organism information of the person subject to measurement and output the currents according to the measured perspiration amounts (step S1). Next, the normalization circuit 113 calculates the normalized perspiration amount based on the current output by the sensor 111 and the conversion function stored previously in the normalization information memory 112 and in which the perspiration amount in the normal case is set to “1” as described above. The normalization circuit 113 writes the calculated perspiration amount to the organism information memory 114 and outputs it to the weighted averaging circuit 131. Likewise, the normalization circuit 123 calculates the normalized perspiration amount based on the current output by the sensor 121 and the conversion function stored previously in the normalization information memory 122. The normalization circuit 123 writes the calculated perspiration amount to the organism information memory 124 and outputs it to the weighted averaging circuit 131 (step S2).

The reliability information generation circuit 115 reads the perspiration amount calculated by the normalization circuit 113 from the organism information memory 124 and calculates the absolute value of the change amount of the read perspiration amount. As described with FIGS. 4A to 5C, the reliability information is generated the value of which becomes smaller when the perspiration amounts changes to become greater than or equal to the predetermined reference value, than when there is no change greater than or equal to the reference value. The reliability information generation circuit 115 outputs the generated reliability information to the weighted averaging circuit 131. Likewise, the reliability information generation circuit 125 generates reliability information based on the perspiration amount calculated by the normalization circuit 123 and outputs the generated reliability information to the weighted averaging circuit 131 (step S3).

The weighted averaging circuit 131 sets the reliability information generated by the reliability information generation circuit 115 to the weight of the perspiration amount calculated by the normalization circuit 113, sets the reliability information generated by the reliability information generation circuit 125 to the weight of the perspiration amount calculated by the normalization circuit 123, and calculates the weighted average of the perspiration amount calculated by the normalization circuit 113 and the perspiration amount calculated by the normalization circuit 123 (step S4).

The exercise load determination circuit 141 determines the exercise load of the person subject to measurement based on (the weighted average of) the perspiration amounts calculated by the weighted averaging circuit 131 (step S5). For example, the exercise load determination circuit 141 previously stores threshold constants k1 and k2 that indicate the perspiration amounts at a boundary of the exercise load levels. When the perspiration amount calculated by the weighted averaging circuit 131 is less than or equal to the constant k1, the exercise load determination circuit 141 determines the exercise load as “normal,” which is a level of an appropriate exercise load. When the perspiration amount calculated by the weighted averaging circuit 131 is greater than the constant k1 and less than or equal to the constant k2, the exercise load determination circuit 141 determines the exercise load as “middle load,” which is a level of a slightly excessive exercise load. When the perspiration amount calculated by the weighted averaging circuit 131 is greater than the constant k2, the exercise load determination circuit 141 determines the exercise load as “large load,” which is a level of an excessive exercise load.

The display circuit 142 displays the exercise load that is determined by the exercise load determination circuit 141. Thereby, the person subject to measurement can perform the exercise with the appropriate load with reference to the exercise load displayed by the display circuit 142.

Next, the result of the determination of the exercise load that is performed by the portable phone 1 will be described.

Table 1 is a table that shows the measurement result of the perspiration amount and the determination result of the exercise load when the measurement is performed normally.

TABLE 1

| | | | | | Reference |
|---|---|---|---|---|---|
| | Sensor 111 | Sensor 121 | | Reference | result 2 |
| Elapsed | Perspiration | Perspiration | Determination | result 1 | (only sensor |
| time | sensor | sensor | result | (non-weight) | 111) |
| 1 minute | 1.2 | 1.2 | Normal** | Normal** | Normal* |
| 5 minutes | 2 | 2 | Normal** | Normal** | Normal* |
| 10 minutes | 3 | 3 | Middle | Middle | Middle |
| | | | load** | load** | load* |
| 15 minutes | 4 | 4 | Large load** | Large load** | Large load* |

Table 1 shows the perspiration amounts (normalized values) measured by the sensors 111 and 121 and the results determined by the portable phone 1 at one minute, five minutes, ten minutes, and fifteen minutes after starting a step exercise when the person subject to measurement performs the step exercise for a constant time after the person subject to measurement rests sufficiently in a room in which the temperature and the humidity are constant. In addition, a reference result 1 shows the determination result that is obtained by a method of determining that there is an error when the difference of the sensor values becomes greater than or equal to the predetermined value, without performing the weighted averaging based on the perspiration amounts shown in the same table. Moreover, a reference result 2 shows the determination result that is obtained by a method of performing the determination using only the measurement value obtained by the sensor 111.

In Table 1, the perspiration amount is a value that is normalized with measurement data of the person subject to measurement in a normal state, as described in FIGS. 3A to 3C. In the determination result, “normal” indicates the exercise amount suitable for the physical ability. The “middle load” indicates a slightly excessive load with respect to the physical ability. The “large load” indicates an excessive load with respect to the physical ability. In Table 1, “**” indicates that measurement accuracy is high and “*” indicates that measurement accuracy is low. The notations in Tables 2 to 8 have the same meanings as the notations described in Table 1.

As shown in Table 1, when the measurement is performed normally, the appropriate determination result is obtained by any determination method.

As such, when the measurement is performed normally, the measurement results obtained by the plurality of sensors are averaged in the determination using the portable phone 1. Therefore, an influence of the measurement error due to the precision of the sensors decreases and the measurement is performed with high accuracy.

Table 2 is a table that shows the measurement result of the perspiration amount and the determination result of the exercise load when the measurement error is generated due to the partial detachment of the sensor terminal.

TABLE 2

| | | | | | Reference |
|---|---|---|---|---|---|
| | Sensor 111 | Sensor 121 | | Reference | result 2 |
| Elapsed | Perspiration | Perspiration | Determination | result 1 | (only sensor |
| time | sensor | sensor | result | (non-weight) | 111) |
| 1 minute | 1.2 | 1.2 | Normal** | Normal** | Normal* |
| 5 minutes | 0.2 | 2 | Normal** | Error | Normal* |
| 10 minutes | 0.3 | 3 | Middle | Error | Normal* |
| | | | load** | | |
| 15 minutes | 0.4 | 4 | Large load** | Error | Normal* |

In Table 2, a measurement condition is the same as that of Table 1. In the case of Table 2, the partial detachment of the sensor terminal 191 is generated between the one minute elapsed time and the five minutes elapsed time. For this reason, at the five minutes elapsed time, the ten minutes elapsed time, and the fifteen minutes elapsed time, a measurement error in which the measurement value obtained by the sensor 111 decreases is generated.

As a result, in the reference result 1 in which the weighted average is not calculated, because the difference of the measurement value obtained by the sensor 111 and the measurement value obtained by the sensor 121 is large, the determination of the load is not performed and an “error” is displayed.

In the reference result 2 using only the measurement value obtained by the sensor 111, the measurement result does not increase to become greater than or equal to the threshold value determined as the “middle load” because of the partial detachment of the sensor terminal, and the determination result of “normal” is obtained regardless of the elapsed time. That is, at the ten minutes elapsed time, the determination result that should be the “middle load” becomes “normal.” Moreover, at the fifteen minutes elapsed time, the determination result that should be the “large load” becomes “normal.” As such, in all of the cases, the inappropriate determination results are shown.

Meanwhile, in the determination performed by the portable phone 1, the rapid decrease in the measurement value when the sensor terminal 191 is partially detached is detected and the reliability information of the measurement value by the sensor 111 is calculated to be small. Thereby, the appropriate determination result is shown even after the partial detachment.

As such, when the measurement error is generated in one sensor, in the determination performed by the portable phone 1, by performing the weight correction and decreasing a contribution degree of the measurement error data with respect to the determination result, the appropriate determination can be performed without generating the measurement error.

As described above, the organism information measuring instrument 11 detects the measurement error such as the partial detachment of the sensor terminal by detecting the rapid change of the organism information, and generates the reliability information according to the detected measurement error. For this reason, the organism information measuring instrument 11 can calculate the weighted average of the organism information based on the reliability information and measure the accurate organism information. Thereby, the portable phone 1 can appropriately determine the exercise load of the person subject to measurement using the organism information measured by the organism information measuring instrument 11.

In particular, in the portable terminal device such as the portable phone, an expensive sensor that has a complicated structure cannot be mounted, because of a request for a small size and a cost decrease. Moreover, a method of carrying the portable terminal device is greatly different according to the habit or the use situation of the user. For this reason, a measurement error can be easily generated when the organism information is measured. In the portable phone 1 described above, small and cheap sensors can be used as the sensors 111 and 121. Moreover, in the portable phone 1, by calculating the weighted average of the plurality of organism information based on the reliability information, the organism information can be measured more accurately, and the exercise load of the person subject to measurement can be determined more appropriately.

The sensors 111 and 121 are not limited to the perspiration sensors described above. The sensors 111 and 121 may be heartbeat sensors that measure heart rates. By measuring the change of the heart rate, the exercise load of the person subject to measurement can be determined, similar to the case in which the perspiration amount is measured.

The number of sensors that are included in the portable phone 1 is not limited to two. Even when the portable phone 1 includes three or more sensors, measurement precision of the organism information can be increased and the exercise load can be appropriately determined by generating the reliability information and taking the weighted average, similar to the case described above.

The portable phone 1 may use both the method of detecting the measurement error by the change amount of the organism information and the method of detecting other measurement errors. For example, the case in which the sensor terminal is detached before starting the measurement can be detected by determining the measurement error when the value of the organism information is less than or equal to the predetermined threshold value. The portable phone 1 can decrease the value of the reliability information of the corresponding organism information when the measurement error is detected. Alternatively, the portable phone 1 may display an error.

The portable phone according to this exemplary embodiment has been described. However, this exemplary embodiment is not limited thereto. For example, this exemplary embodiment may be applied to another portable terminal device such as a perm top personal computer. This exemplary embodiment may be applied to a wristwatch, an exercise machine, and an apparatus dedicated for organism information measurement to be fixed to the body with a belt or the like.

The organism information memory 114 may store the organism information which is output by the sensor 111 and is before normalized, and the reliability information generation circuit 115 may generate the reliability information based on the organism information. In particular, as described above, when the normalization circuit 113 outputs the level of the perspiration amount, the rapid change of the organism information that is output by the sensor 111 cannot be detected from the normalized organism information. Therefore, in this case, the organism information memory needs to store the organism information which is output by the sensor 111 and is before normalized, and the reliability information generation circuit 115 needs to generate the reliability information based on this organism information. This is the same in the organism information memory 124 and the reliability information generation circuit 125.

### Second Exemplary Embodiment

In the first exemplary embodiment, the case in which the portable phone includes the plurality of sensors to measure the same types of organism information has been described. Meanwhile, in this exemplary embodiment, the case in which the portable phone includes a plurality of sensors to measure different types of organism information will be described.

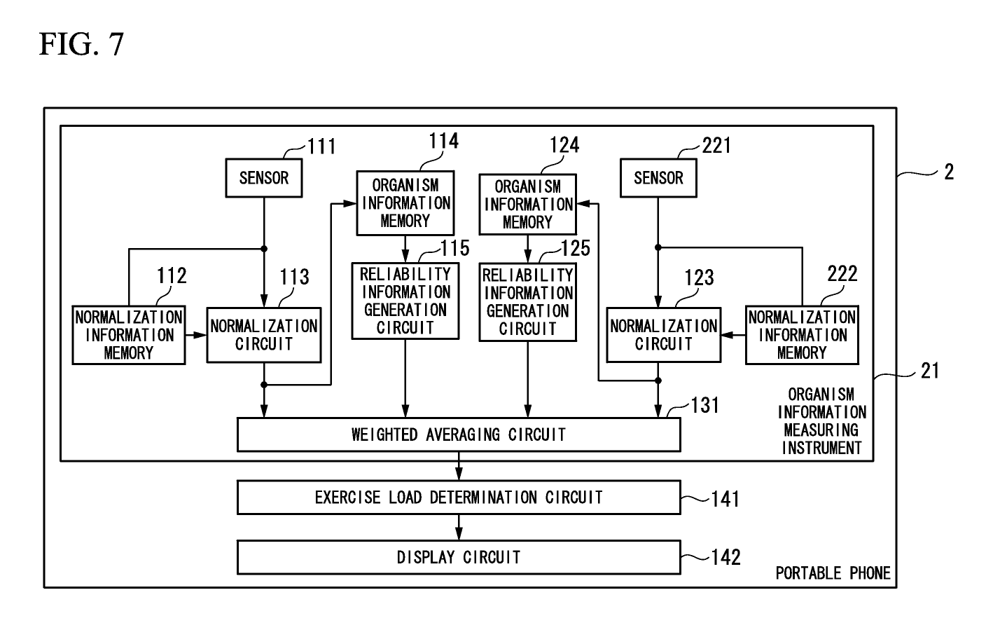

FIG. 7 is a configuration diagram showing a schematic configuration of a portable phone (portable terminal device) 2 according to the second exemplary embodiment of the present invention. In FIG. 7, the portable phone 2 includes an organism information measuring instrument 21, an exercise load determination circuit 141, and a display circuit 142. The organism information measuring instrument 21 includes sensors 111 and 221, normalization information memories 112 and 222, normalization circuits 113 and 123, organism information memories 114 and 124, reliability information generation circuits 115 and 125, and a weighted averaging circuit 131. In FIG. 7, the components that have the same functions as those of the components of FIG. 1 are denoted by the same reference symbols (111 to 115, 123 to 125, 131, 141, and 142) and the description thereof is omitted.

Similar to the portable phone 1, the portable phone 2 includes components other than the components shown in FIG. 7, such as a voice processing circuit to convert a voice signal into an electric signal when a person subject to measurement makes a call and a communication circuit to perform a call to another phone.

An arrangement of sensor terminals of the sensors 111 and 221 is the same as the arrangement of the sensor terminals 191 and 192 of FIGS. 2B and 2C.

The sensor 221 is a heartbeat sensor and measures a heart rate of the person subject to measurement.

The normalization information memory 222 stores normalization information that is information to perform normalization by the normalization circuit 123.

The normalization information that is stored in the normalization information memory 222 is a function of normalizing a heart rate measured by the sensor 221. The normalization information that is stored in the normalization information memory 222 converts a heart rate in the normal case into a reference value “1” of a normalized heart rate. The normalization information that is stored in the normalization information memory 222 converts a heart rate in the case of the predetermined load exercise in which the normalization information memory 112 sets a perspiration amount to “3” into a normalized heart rate “3.”

As such, by normalizing the plurality of types of organism information such as the perspiration amount and the heart rate based on the common reference, such as the organism information of the person subject to measurement in the normal case or the organism information in the case of the predetermined load exercise, the plurality of types of organism information can be compared, regardless of the difference of units owing to the difference of the types of the organism information.

Next, the result of the determination of the exercise load that is performed by the portable phone 2 will be described.

Table 3 is a table that shows the measurement results of the perspiration amount and the heart rate and the determination result of the exercise load when the measurement is performed normally.

TABLE 3

| | | | | | Reference |
|---|---|---|---|---|---|
| | Sensor 111 | Sensor 221 | | Reference | result 2 |
| Elapsed | Perspiration | Heartbeat | Determination | result 1 | (only sensor |
| time | sensor | sensor | result | (non-weight) | 111) |
| 1 minute | 1.2 | 1.2 | Normal** | Normal** | Normal* |
| 5 minutes | 2 | 2.2 | Normal** | Normal** | Normal* |
| 10 minutes | 3 | 3.4 | Large load** | Large load** | Middle |
| | | | | | load* |
| 15 minutes | 4 | 4.4 | Large load** | Large load** | Large load* |

Table 3 shows the perspiration amounts (normalized values) measured by the sensor 111, the heart rates (normalized values) measured by the sensor 221, and the results determined by the portable phone 2 at one minute, five minutes, ten minutes, and fifteen minutes after starting a step exercise when the person subject to measurement performs the step exercise for a constant time after the person subject to measurement rests sufficiently in a room in which the temperature and the humidity are constant. In addition, a reference result 1 shows the determination result that is obtained by a method of determining that there is an error when the difference of the sensor values becomes greater than or equal to the predetermined value, without performing the weighted averaging based on the perspiration amounts and the heart rates shown in Table 3. Moreover, a reference result 2 shows the determination result that is obtained by a method of performing the determination using only the measurement value obtained by the sensor 111.

Similar to the case of Table 1, in Table 3, the perspiration amount and the heart rate are values that are normalized with the measurement data of the person subject to measurement in the normal state. The notations of “normal,” “middle load,” “large load,” “**,” and “*” for the determination results have the same meanings as the notations described in Table 1.

In Table 3, at the ten minutes elapsed time, the determination result by the portable phone 2 and the reference result 1 become the “large load.” By contrast, the reference result 2 becomes the “middle load.” This is because the time difference is generated between the increase in the exercise load and the increase in the perspiration amount, and the increase in the exercise load is not sufficiently reflected in the reference result 2 based on only the perspiration amount so that the determination of the “middle load” is given. Meanwhile, because the time difference between the increase in the exercise load and the increase in the heart rate is small, the increase in the exercise load is appropriately reflected in the determination result by the portable phone 2 using both the perspiration amount and the heart rate and the reference result 1 and the determination of the “large load” is given. At the remaining elapsed times, the appropriate determination results are obtained by any determination method.

As such, when the measurement is performed normally, the measurement results obtained by the plurality of types of sensors are averaged in the determination using the portable phone 2. Therefore, an influence of the characteristic for each type of the organism information or the individual difference decreases and the determination is performed with higher precision. For example, at the ten minutes elapsed time, the time difference may be generated according to the type of the organism information until the change of the exercise load is reflected in the change of the organism information. By measuring the plurality of types of organism information, the influence of the time difference can be decreased. For example, in the case of the person subject to measurement having the small perspiration amount, if the change of the perspiration amount is small even when the person subject to measurement performs the exercise and the exercise load is determined based on only the perspiration amount, precision may be lowered. In this case, by measuring the heart rate in addition to the measurement of the perspiration amount, a measurement value in which the change according to the exercise load is large is obtained and the determination can be performed with higher precision.

Table 4 is a table that shows the measurement results of the perspiration amount and the heart rate and the determination result of the exercise load when the measurement error is generated due to the partial detachment of the sensor terminal.

TABLE 4

| | | | | | Reference |
|---|---|---|---|---|---|
| | Sensor 111 | Sensor 221 | | Reference | result 2 |
| Elapsed | Perspiration | Heartbeat | Determination | result 1 | (only sensor |
| time | sensor | sensor | result | (non-weight) | 111) |
| 1 minute | 1.2 | 1.2 | Normal** | Normal** | Normal* |
| 5 minutes | 0.2 | 2.2 | Normal** | Error | Normal* |
| 10 minutes | 0.3 | 3.4 | Large load** | Error | Normal* |
| 15 minutes | 0.4 | 4.4 | Large load** | Error | Normal* |

In Table 4, a measurement condition is the same as the measurement condition of Table 3. In the case of Table 4, the partial detachment of the sensor terminal is generated between the one minute elapsed time and the five minutes elapsed time. For this reason, at the five minutes elapsed time, the ten minutes elapsed time, and the fifteen minutes elapsed time, a measurement error in which the measurement value obtained by the sensor 111 decreases is generated.

As a result, in the reference result 1 in which the weighted average is not calculated, because the difference between the measurement value obtained by the sensor 111 and the measurement value obtained by the sensor 221 is great, the determination of the load is not performed and an “error” is displayed.

In the reference result 2 using only the measurement value obtained by the sensor 111; the measurement result does not increase to become greater than or equal to the threshold value determined as the “middle load” because of the partial detachment of the sensor terminal, and the determination result of “normal” is obtained regardless of the elapsed times. That is, at the ten minutes elapsed time and the fifteen minutes elapsed time, the determination result that should be the “large load” becomes “normal” and the inappropriate determination results are shown.

Meanwhile, in the determination performed by the portable phone 2, the rapid decrease in the measurement value when the sensor terminal is partially detached is detected and the reliability information of the measurement value by the sensor 111 is calculated to be small. Thereby, the appropriate determination result is shown after the partial detachment.

As such, when the measurement error is generated in one sensor, in the determination performed by the portable phone 1, the weight correction is performed and a contribution degree of the measurement error data with respect to the determination result is decreased. As a result, the appropriate determination can be performed without generating the measurement error.

### Third Exemplary Embodiment

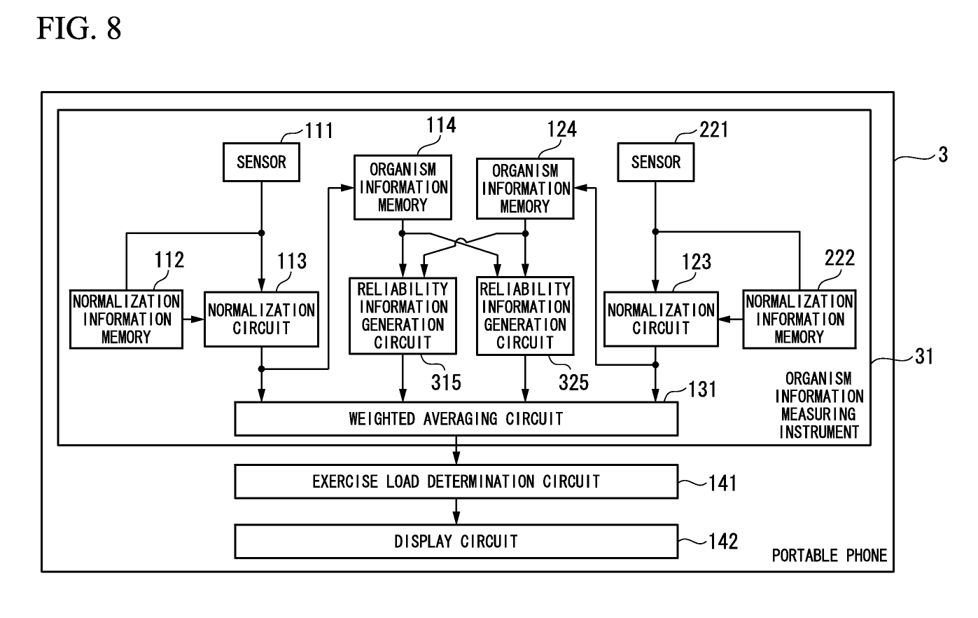

FIG. 8 is a configuration diagram showing a schematic configuration of a portable phone (portable terminal device) 3 according to a third exemplary embodiment of the present invention. In FIG. 8, the portable phone 3 includes an organism information measuring instrument 31, an exercise load determination circuit 141, and a display circuit 142. The organism information measuring instrument 31 includes sensors 111 and 221, normalization information memories 112 and 222, normalization circuits 113 and 123, organism information memories 114 and 124, reliability information generation circuits 315 and 325, and a weighted averaging circuit 131. In FIG. 8, the components that have the same functions as those of the components of FIG. 1 are denoted by the same reference symbols (111 to 114, 221, 222, 123, 124, 131, 141, and 142) and the description thereof is omitted.

Similar to the portable phone 1, the portable phone 3 includes components other than the components shown in FIG. 8, such as a voice processing circuit to convert a voice signal into an electric signal when a person subject to measurement makes a call and a communication circuit to perform a call to another phone.

An arrangement of sensor terminals of the sensors 111 and 221 is the same as the arrangement of the sensor terminals 191 and 192 of FIG. 2.

The reliability information generation circuit 315 generates reliability information in which the difference between an increase/decrease of organism information calculated by the normalization circuit 113 and an increase/decrease of organism information calculated by the normalization circuit 123 is added to the reliability information generated by the reliability information generation circuit 115 (refer to FIG. 1) according to the first exemplary embodiment.

Specifically, the reliability information generation circuit 315 reads the normalized perspiration amount from the organism information memory 114 and determines whether the perspiration amount is increasing or decreasing at the present time. Likewise, the reliability information generation circuit 315 reads the normalized heart rate from the organism information memory 124 and determines whether the heart rate is increasing, decreasing, or does not change at the present time.

The case will be described in which the reliability information generation circuit 315 determines that both the perspiration amount read from the organism information memory 114 and the heart rate read from the organism information memory 124 increase or do not change or determines that both the perspiration amount and the heart rate decrease or do not change. In this case, the reliability information generation circuit 315 calculates, as the reliability information, a value obtained by adding “0.3” to a value of the reliability information based on the change amount of the organism information described in the second exemplary embodiment. For example, as shown in FIG. 4B, when the change amount of the organism information is less than or equal to the reference value c, the value of the reliability information based on the change amount of the organism information is “1” and the reliability information generation circuit 315 calculates “1.3” as the value of the reliability information.

The case will be described in which the reliability information generation circuit 315 determines that the perspiration amount read from the organism information memory 114 is increasing and the heart rate read from the organism information memory 124 is decreasing. In this case, the reliability information generation circuit 315 calculates, as the reliability information, a value obtained by adding “0.1” to the value of the reliability information based on the change amount of the organism information described in the second exemplary embodiment.

The case will be described in which the reliability information generation circuit 315 determines that the perspiration amount read from the organism information memory 114 is decreasing and the heart rate read from the organism information memory 124 is increasing. In this case, the reliability information generation circuit 315 calculates, as the reliability information, a value obtained by adding “0” to the value of the reliability information based on the change amount of the organism information described in the second exemplary embodiment, that is, a value having no addition.

As such, when the plurality of organism information show the same increase/decrease tendency, it is considered that the value of the organism information changes with reflecting the exercise load of the person subject to measurement. By using the value, the exercise load can be anticipated to be appropriately determined.

Meanwhile, when the plurality of organism information show different increase/decrease tendencies, the change of the value of any organism information is not reflecting the exercise load of the person subject to measurement and the value of the organism information may cause the measurement error such as the gradual detachment of the sensor terminal. Therefore, the increase/decrease tendency of the organism information is added to the reliability information. At this time, it is considered that reliability of the organism information of which the value decreases is low, such as in the cases where the sensor terminal is gradually detached or the sensitivity is gradually lowered due to the failure of the sensor. Therefore, as described above, reliability information having a smaller value is added to the organism information of which the value decreases, compared to the organism information of which the value increases.

It is reasonably considered that the value of the organism information increases with a delay after the exercise load decreases, like the case in which the organism information such as the perspiration amount increases or decreases after the exercise load increases or decreases, for example. Therefore, the reliability information of the organism information of which the value increases may not be high. Therefore, the value of the reliability information based on the increase/decrease tendency of the organism information is set to relatively smaller than the value of the reliability information based on the change amount of the organism information described in the second exemplary embodiment.

Next, the result of the determination of the exercise load that is performed by the portable phone 3 will be described.

Table 5 is a table that shows the measurement results of the perspiration amount and the heart rate and the determination result of the exercise load when the measurement is performed normally.

TABLE 5

| | | | | | Reference |
|---|---|---|---|---|---|
| | Sensor 111 | Sensor 221 | | Reference | result 2 |
| Elapsed | Perspiration | Heartbeat | Determination | result 1 | (only sensor |
| time | sensor | sensor | result | (non-weight) | 111) |
| 1 minute | 1.2 | 1.2 | Normal** | Normal** | Normal* |
| 5 minutes | 2 | 2.2 | Normal** | Normal** | Normal* |
| 10 minutes | 3 | 3.4 | Large load** | Large load** | Middle |
| | | | | | load* |
| 15 minutes | 4 | 4.4 | Large load** | Large load** | Large load* |

Table 5 shows the perspiration amounts (normalized values) measured by the sensor 111, the heart rates (normalized values) measured by the sensor 221, and the results determined by the portable phone 3 at one minute, five minutes, ten minutes, and fifteen minutes after starting a step exercise when the person subject to measurement performs the step exercise for a constant time after the person subject to measurement rests sufficiently in a room in which the temperature and the humidity are constant. In addition, a reference result 1 shows the determination result that is obtained by a method of determining that there is an error when the difference of the sensor values becomes greater than or equal to the predetermined value, without performing the weighted averaging based on the perspiration amounts and the heart rates shown in the same table. Moreover, a reference result 2 shows the determination result that is obtained by a method of performing the determination using only the measurement value obtained by the sensor 111.

Similar to the case of Table 1, in Table 5, the perspiration amount and the heart rate are values that are normalized with the measurement data of the person subject to measurement in the normal state. The notations of “normal,” “middle load,” “large load,” “**,” and “*” for the determination results have the same meanings as the notations in described Table 1.

Similar to Table 3, in Table 5, at the ten minutes elapsed time, because of the time difference between the increase in the exercise load and the increase in the perspiration amount, the increase in the exercise load is not sufficiently reflected and the reference result 2 becomes the “middle load.” At the remaining elapsed times, the appropriate determination results are obtained by any determination method.

As such, when the measurement is performed normally, the measurement results obtained by the plurality of types of sensors are averaged in the determination using the portable phone 3, similar to the portable phone 2. Therefore, an influence of the characteristic for each type of the organism information or the individual difference decreases and the determination is performed with higher precision.

Table 6 is a table that shows the measurement results of the perspiration amount and the heart rate and the determination result of the exercise load when the measurement error is generated due to the partial detachment of the sensor terminal.

TABLE 6

| | | | | | Reference |
|---|---|---|---|---|---|
| | Sensor 111 | Sensor 221 | | Reference | result 2 |
| Elapsed | Perspiration | Heartbeat | Determination | result 1 | (only sensor |
| time | sensor | Sensor | result | (non-weight) | 111) |
| 1 minute | 1 | 1.2 | Normal** | Normal** | Normal* |
| 5 minutes | 0.7 | 2.2 | Normal** | Error | Normal* |
| 10 minutes | 0.8 | 3.4 | Large load** | Error | Normal* |
| 15 minutes | 0.5 | 4.4 | Large load** | Error | Normal* |

In Table 6, a measurement condition is the same as the measurement condition of Table 5. In Table 6, the partial detachment of the sensor terminal is generated between the one minute elapsed time and the five minutes elapsed time. For this reason, when the five minutes elapsed time, the ten minutes elapsed time, and the fifteen minutes elapsed time, a measurement error in which the measurement value obtained by the sensor 111 decreases is generated.

As a result, in the reference result 1 in which the weighted average is not calculated, because the difference between the measurement value obtained by the sensor 111 and the measurement value obtained by the sensor 221 is great, the determination of the load is not performed and an “error” is displayed.

In the reference result 2 using only the measurement value obtained by the sensor 111, the measurement result does not increase to become greater than or equal to the threshold value determined as the “middle load” because of the partial detachment of the sensor terminal, and the determination result of “normal” is obtained regardless of the elapsed time. That is, at the ten minutes elapsed time and the fifteen minutes elapsed time, the determination result that should be the “large load” becomes “normal” and the inappropriate determination results are shown.

Meanwhile, in the determination performed by the portable phone 3, the rapid decrease in the measurement value when the sensor terminal is partially detached is detected and the reliability information of the measurement value by the sensor 111 is calculated to be small. Thereby, the appropriate determination result is shown even after the partial detachment.

As such, when the measurement error is generated in one sensor, in the determination performed by the portable phone 1, the weight correction is performed and a contribution degree of the measurement error data with respect to the determination result is decreased. As a result, the appropriate determination can be performed without generating the measurement error.

The organism information measuring instrument 31 may include three or more sensors. The method according to this exemplary embodiment is effective particularly in the case in which the organism information measuring instrument 31 includes the three or more sensors.

For example, the organism information measuring instrument 31 may include a perspiration sensor, a heartbeat sensor, and a respiration sensor. In this case, if the heart rate and the respiration rate decrease and the perspiration amount increases, it is considered that the perspiration amount is less influenced by the exercise than the heart rate and the respiration rate, and an influence of the large exercise load appears in the perspiration amount late after the exercise load decreases. Therefore, appropriate determination according to the current exercise load can be anticipated to be performed by raising the reliability of the heart rate and the inspiration rate showing the same decrease tendency and lowering the reliability of the perspiration amount showing the increase tendency which is different from it. As such, when there is organism information showing the increase/decrease tendency different from the increase/decrease tendency of the other organism information in the organism information measured by the three or more sensors, appropriate determination can be anticipated to be performed by raising the reliability of the organism information showing the same increase/decrease tendency, by decision by majority.

The organism information measuring instrument 31 may include sensors that measure the same type of organism information. In this case, the reliability of the organism information that shows the increase/decrease tendency different from the increase/decrease tendency of the other sensors due to the failure of the sensor can be lowered and the appropriate determination can be anticipated to be performed.

### Fourth Exemplary Embodiment

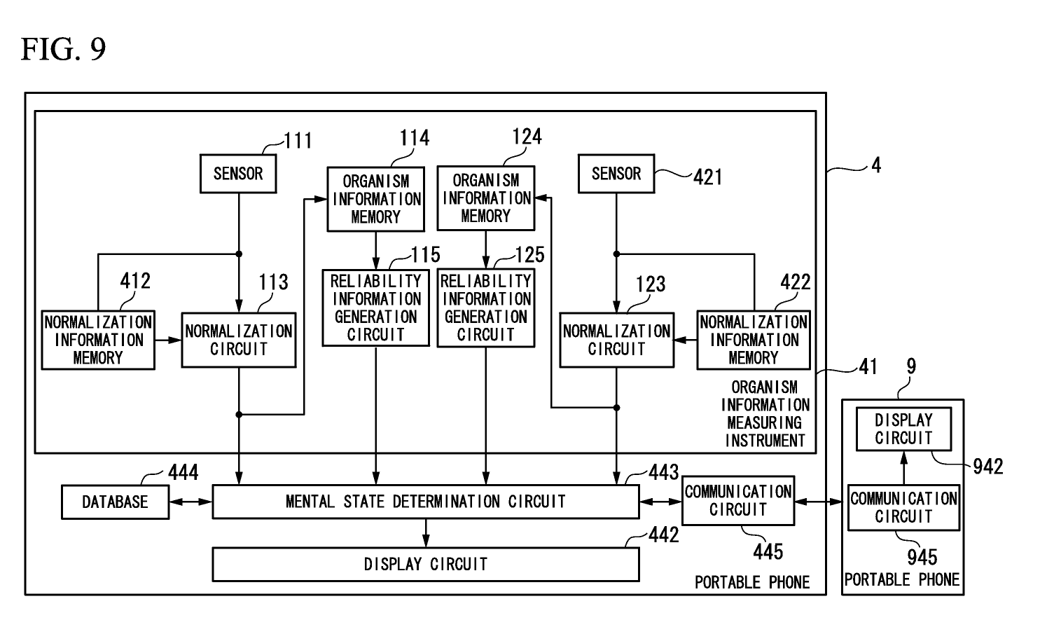

FIG. 9 is a configuration diagram showing a schematic configuration of a portable phone (portable terminal device) 4 according to a fourth exemplary embodiment of the present invention. In FIG. 9, the portable phone 4 includes an organism information measuring instrument 41, a display circuit 442, a mental state determination circuit 443, a database 444, and a communication circuit (transmission circuit) 445. The organism information measuring instrument 41 includes sensors 111 and 421, normalization information memories 412 and 422, normalization circuits 113 and 123, organism information memories 114 and 124, and reliability information generation circuits 115 and 125.

The portable phone 4 performs communication with a portable phone 9. The portable phone 9 includes a display circuit 942 and a communication circuit 945.

In FIG. 9, the components that have the same functions as those of the components of FIG. 1 are denoted by the same reference symbols (111, 113 to 115, and 123 to 125) and the description thereof is omitted.

The portable phone 4 includes a component other than the components shown in FIG. 9, such as a voice processing circuit to convert a voice signal into an electric signal when a person subject to measurement makes a call.

The sensor 421 is a body temperature sensor and measures a body temperature of the person subject to measurement.

The normalization information memory 412 stores normalization information to normalize the perspiration amount measured by the sensor 111. A function of setting the perspiration amount of the person subject to measurement in the normal case to “1” and setting the perspiration amount of the person subject to measurement in a predetermined tense state such as when the person subject to measurement is threatened with predetermined words and volumes of voices to “5” is previously determined. The normalization information memory 412 stores the function as the normalization information.

The normalization information memory 422 stores normalization information to normalize the body temperature measured by the sensor 421. Similar to the case of the normalization information memory 412, a function of setting the body temperature of the person subject to measurement in the normal case to “1” and setting the body temperature of the person subject to measurement in a predetermined tense state such as when the person subject to measurement is threatened with predetermined words and volumes of voices to “5” is previously determined. The normalization information memory 422 stores the function as the normalization information.

The database 444 previously stores a correspondence table between organism information and mental state information that is used when the mental state determination circuit 443 determines a mental state. For example, the mental state information that is stored in the database 444 takes a value of any one of “rest” showing that the person subject to measurement is in a restful state and “tension” showing that the person subject to measurement is in a tense state. The database 444 associates a predetermined range of the perspiration amount, the body temperature, and the reliability information with the “rest” or the “tension” for every predetermined range and stores them. Thereby, if the values of the perspiration amount, the body temperature, and the reliability information are determined, the mental state information that is associated with the values can be read from the database 444.

The mental state determination circuit 443 performs the determination based on the normalized perspiration amount calculated by the normalization circuit 113, the reliability information of the perspiration amount generated by the reliability information generation circuit 115, the normalized body temperature calculated by the normalization circuit 123, and the reliability information of the body temperature generated by the reliability information generation circuit 125. That is, based on the information, the mental state determination circuit 443 determines whether the mental state of the person subject to measurement is in a restful state or in a tense state. The mental state determination circuit 443 refers to the database 444, reads the mental state information associated with the perspiration amount, the body temperature, and the reliability information, and thereby determines the mental state of the person subject to measurement.

The display circuit 442 includes a speaker and displays the mental state determined by the mental state determination circuit 443 using a voice. In this exemplary embodiment, when the person subject to measurement makes a call using the portable phone 4, the mental state determination circuit 443 determines the mental state. In this case, because the person subject to measurement cannot view a display screen of the portable phone 4, the display circuit 442 displays the mental state using the voice.

The portable phone 9 receives mental state information transmitted by the portable phone 4 and displays it. The communication circuit 945 receives the mental state information transmitted by the communication circuit 445 of the portable phone 4 and outputs the received mental state information to the display circuit 942. The display circuit 942 includes a display screen such as a liquid crystal panel and displays the mental state information output from the communication circuit 945 on the display screen. Similar to the display circuit 442, the display circuit 942 may include a speaker and display the mental state information output from the communication circuit 945 using a voice.

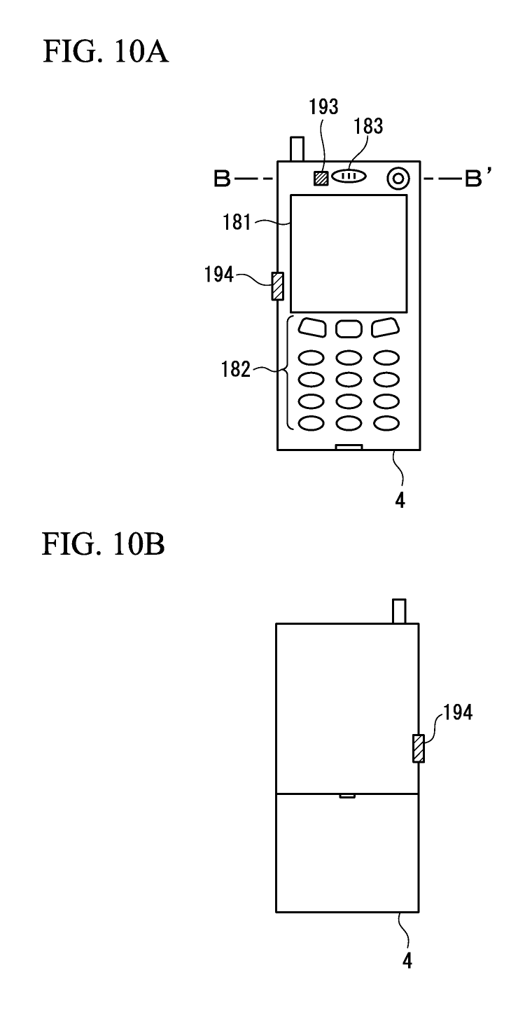

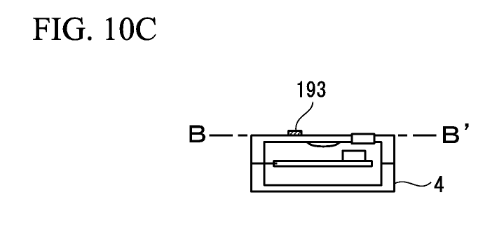

FIGS. 10A and 10B are external views showing an external shape of the portable phone 4. FIG. 10C is a cross-sectional view showing a cross-section of the portable phone 4.

FIG. 10A is an external view of the front side of the portable phone 4. In FIG. 10A, the portable phone 4 includes a display screen 181, an operation button 182, a speaker 183, and sensor terminals 193 and 194. In FIG. 10A, the components that have the same functions as those of the components of FIG. 2A are denoted by the same reference symbols (181 to 183) and the description thereof is omitted. The speaker 183 is the speaker that is included by the display circuit 442.

The sensor terminal 193 is a terminal to measure the perspiration amount by the sensor 111. The sensor terminal 194 is a terminal to measure the body temperature by the sensor 421.

FIG. 10B is an external view of the back side of the portable phone 4. As shown in FIGS. 10A and 10B, the sensor terminal 194 protrudes at the side face of the portable phone 1. The person subject to measurement holds the portable phone 4 such that the sensor terminal 194 contacts a finger of the person subject to measurement. In this state, if the person subject to measurement sweats, the current that flows through the sensor 111 changes. The sensor 111 outputs the current.

FIG. 10C is a cross-sectional view of the portable phone 4 taken along the line B-B′ of FIG. 10A. As shown in FIGS. 10A and 10C, the sensor terminal 193 protrudes at the front face of the portable phone 4. The person subject to measurement holds the portable phone 4 such that the sensor terminal 193 contacts the face of the person subject to measurement and makes a call. In this state, the sensor 421 measures the temperature of a contact portion as the body temperature of the person subject to measurement.

Next, the result of the determination of the mental state that is performed by the portable phone 4 will be described.

Table 7 is a table that shows the measurement results of the perspiration amount and the body temperature and the determination result of the mental state when the measurement is performed normally.

TABLE 7

| | | Sensor 421 | | | Reference |
|---|---|---|---|---|---|
| | Sensor 111 | Body | | Reference | result 2 |
| Elapsed | Perspiration | temperature | Determination | result 1 | (only sensor |
| time | sensor | sensor | result | (non-weight) | 111) |
| 1 minute | 3.1 | 3 | Rest** | Rest** | Rest* |
| 5 minutes | 10 | 9.6 | Tension** | Tension** | Tension* |
| 10 minutes | 6.5 | 6.5 | Rest** | Rest** | Rest* |

In Table 7, the perspiration amounts (normalized values) measured by the sensor 111, the body temperatures (normalized values) measured by the sensor 421, and the results determined by the portable phone 4 at one minute, five minutes, and ten minutes after starting calling when the person subject to measurement makes a call for ten minutes after the person subject to measurement rests sufficiently in a room in which the temperature and the humidity are constant are shown. In addition, a reference result 1 shows the determination result that is obtained by a method of determining that there is an error when the difference of the sensor values becomes greater than or equal to the predetermined value, without performing the weighted averaging based on the perspiration amounts and the body temperatures shown in Table 7. Moreover, a reference result 2 shows the determination result that is obtained by a method of performing the determination using only the measurement value obtained by the sensor 111.

In the measurement of Table 7, at approximately five minutes after starting calling, a calling partner of the person subject to measurement talks in a strong tone with anger in order to cause tension in the person subject to measurement.

Similar to the case of Table 1, the perspiration amount and the body temperature of Table 7 are values that are normalized with measurement data of the person subject to measurement in the normal case. The determination result “rest” shows that the person subject to measurement is in a restful mental state and “tension” shows that the person subject to measurement is in a tense mental state. In Table 7, “*” shows that measurement accuracy is high and “*” shows that measurement accuracy is low.

As shown in Table 7, when the measurement is performed normally, the appropriate determination result is obtained by any determination method.

As such, when the measurement is performed normally, the determination is performed using the measurement results obtained by the plurality of types of sensors in the determination using the portable phone 4. For this reason, an influence of the characteristic for each type of the organism information or the individual difference decreases and the determination is performed with higher precision.

Table 8 is a table that shows the measurement results of the perspiration amount and the body temperature and the determination result of the mental state when the measurement error is generated due to the partial detachment of the sensor terminal.

TABLE 8

| | | Sensor 421 | | | Reference |
|---|---|---|---|---|---|
| | Sensor 111 | Body | | Reference | result 2 |
| Elapsed | Perspiration | temperature | Determination | result 1 | (only sensor |
| time | sensor | sensor | result | (non-weight) | 111) |
| 1 minute | 3.1 | 3 | Rest** | Rest** | Rest* |
| 5 minutes | 5 | 9.6 | Tension** | Error | Rest* |
| 10 minutes | 3.2 | 6.5 | Rest** | Error | Rest* |

In Table 8, a measurement condition is the same as the measurement condition of Table 7. In Table 8, the partial detachment of the sensor terminal is generated between the one minute elapsed time and the five minutes elapsed time. For this reason, at the five minutes elapsed time and the ten minutes elapsed time, a measurement error in which the measurement value obtained by the sensor 111 decreases is generated.

As a result, in the reference result 1 in which the weighted average is not calculated, at the five minutes elapsed time and the ten minutes elapsed time, because the difference between the measurement value obtained by the sensor 111 and the measurement value obtained by the sensor 421 is large, the determination of the mental state is not performed and an “error” is displayed.

In the reference result 2 using only the measurement value obtained by the sensor 111, at the five minutes elapsed time, the measurement result does not increase to become greater than or equal to the threshold value determined as the “tension” because of the partial detachment of the sensor terminal, and the inappropriate determination result of “rest” is obtained.

Meanwhile, in the determination performed by the portable phone 4, the rapid decrease in the measurement value when the sensor terminal is partially detached is detected and the reliability information of the measurement value by the sensor 111 is calculated to be small. Thereby, the appropriate determination result is shown even after the partial detachment.

As such, when the measurement error is generated in one sensor, in the determination performed by the portable phone 4, the weight correction is performed and a contribution degree of the measurement error data with respect to the determination result is decreased. As a result, the appropriate determination can be performed without generating the measurement error.

As described above, the portable phone 4 determines the mental state of the person subject to measurement and transmits the mental state to the portable phone 9 of the calling partner to provide new information of a mental state of a person who makes a call, in addition to the transmission of a conventional message or music.

Moreover, in the case where the mental state determination circuit 443 further determines the trustworthiness of the talking of the person subject to measurement based on the mental state information and transmits it to the portable phone 9 of the calling partner, it is possible to provide a service for displaying the trustworthiness of the talking. Alternatively, in the case where the mental state determination circuit 443 determines a goodwill degree with respect to the calling partner as the mental state of the person subject to measurement and displays it on the display circuit 442 or transmits it to the portable phone 9 of the calling partner, it is possible to provide compatibility test services between people who makes a call. As such, by determining the mental state of the person subject to measurement by the portable phone 4, it is possible to provide various services.

The mental state determination circuit 443 and the database 444 may be provided outside the portable phone 4. For example, a server device (not shown in the figures) may include the mental state determination circuit 443 and the database 444. In this case, if the server device receives the organism information or the reliability information from the portable phone 4, the mental state determination circuit 443 reads the mental state information associated with the received organism information or reliability information, from the database 444. The server device transmits the read mental state information to the portable phone 4 and the display circuit 442 of the portable phone 4 receives the received mental state information.

When the database 444 is provided inside the portable phone 4, the storage capacity of the database 444 is restricted by the restriction of the size of the portable phone 4. Meanwhile, when the database 444 is provided outside the portable phone 4, the database 444 can have a larger storage capacity. Thereby, the mental state determination can be performed more appropriately using more various types of organism information; for example, the mental state can be determined based on the heart rate in addition to the above-described perspiration amount and body temperature. Alternatively, the mental state can be determined in further detail; for example, the database 444 can store the mental state information for each minute range of the organism information or the reliability information.

Furthermore, by providing the mental state determination circuit 443 and the database 444 outside the portable phone 4, a plurality of portable phones can share the mental state determination circuit 443 and the database 444. Thereby, the correspondence table can be easily managed; for example, the correspondence table used by a plurality of portable phones can be updated at one time by updating the correspondence table stored in the database 444.

The display circuit 442 or 942 may display the mental state information using a method other than the voice display described above. For example, the display circuit 442 may include a display screen and may visually display the mental state information after a call ends. For example, an avatar (virtual incarnation) of the person subject to measurement may be displayed on the display screen and the mental state may be expressed by an expression of a face of the avatar.

A program for realizing all or part of the functions of the portable phones 1 to 4 may be recorded in a computer readable recording medium, the program recorded in the recording medium may be read and executed by a computer system, and thereby processing of each unit may be executed. Here, the “computer system” includes an OS or hardware such as a peripheral apparatus.

If the “computer system” uses a WWW system, it includes a homepage provision environment (or display environment).

The “computer readable recording medium” means a portable medium such as a flexible disk, a magneto optical disc, a ROM and a CD-ROM and a storage device such as a hard disk embedded in the computer system. The “computer readable recording medium” includes a medium that holds a program dynamically for a short time, like a communication line when the program is transmitted through a network such as the Internet or communication lines such as telephone lines, and a medium that holds a program for a constant time, like a volatile memory in the computer system becoming a server or a client in that cases. The program may realize part of the functions described above and the functions may be realized by a combination with the program previously recorded in the computer system.

The exemplary embodiments of the present invention have been described in detail with reference to the drawings. However, the specific configuration is not limited to the exemplary embodiments and a design may be changed without departing from the scope of the present invention.

This application is based upon and claims the benefit of priority from Japanese patent application No. 2010-024456, filed Feb. 5, 2010, the disclosure of which is incorporated herein in its entirety by reference.

### INDUSTRIAL APPLICABILITY

The present invention is suitable for an organism information measuring instrument, an organism information measuring method, a program, and a portable terminal device including the organism information measuring instrument.

### DESCRIPTION OF REFERENCE SYMBOLS

1 to 4 Portable phone
11, 21, 31, 41 Organism information measuring instrument
111, 121, 221, 421 Sensor
112, 122, 222, 412, 422 Normalization information memory
113, 123 Normalization circuit
114, 124 Organism information memory
115, 125, 315, 325 Reliability information generation circuit
131 Weighted averaging circuit
141 Exercise load determination circuit
142, 442 Display circuit
181 Display screen
182 Operation button
183 Speaker
191 to 194 Sensor terminal
443 Mental state determination circuit
444 Database
445 Communication circuit

1. An organism information measuring instrument, comprising:
a sensor that measures organism information;
a normalization circuit that normalizes the organism information by converting a value of the organism information based on preset normalization information; and
a reliability information generation circuit that detects a change amount greater than or equal to a predetermined value in a predetermined time period, with respect to the organism information or the normalized organism information, and generates reliability information indicating lower reliability as the change amount is greater.

2. The organism information measuring instrument according to claim 1, comprising:
a plurality of the sensors;
a plurality of the normalization circuits that normalize the organism information measured by each of the sensors;
a plurality of the reliability information generation circuits that generate the reliability information for each of the organism information or each of the normalized organism information; and
a weighted averaging circuit that performs weighted averaging on pieces of the normalized organism information with larger weight for the organism information having higher reliability based on the reliability information.

3. The organism information measuring instrument according to claim 2,
wherein the organism information measuring instrument comprises a plurality of types of the sensors and measures a plurality of types of the organism information, and
the weighted averaging circuit calculates a weighted average of the plurality of types of normalized organism information.

4. The organism information measuring instrument according to claim 2,
wherein the reliability information generation circuits determine an increase/decrease of values of the organism information measured by the plurality of sensors, the reliability information generation circuits generate the reliability information indicating higher reliability in a case where all the values of the organism information increase or do not change and in a case where all the values of the organism information decrease or do not change, and the reliability information generation circuits generate the reliability information indicating lower reliability in a case where the value of one organism information increases and the value of another organism information decreases.

5. A portable terminal device comprising the organism information measuring instrument according to claim 3,
wherein the plurality of types of sensors include a perspiration sensor which measures a perspiration amount and a heartbeat sensor which measures a heart rate,
the weighted averaging circuit calculates a weighted average of the plurality of types of normalized organism information including the normalized perspiration amount and the normalized heart rate, and
the portable terminal device comprises:
an exercise load determination circuit that determines an exercise load of an person subject to measurement based on the weighted average; and
a display circuit that displays the determined exercise load.

6. A portable terminal device comprising the organism information measuring instrument according to claim 1, the organism information measuring instrument comprising:
a plurality of the sensors;
a plurality of normalization circuits that normalize the organism information measured by each of the sensors, and
a plurality of the reliability information generation circuits that generate the reliability information for each of the organism information or each of the normalized organism information,
wherein the plurality of the sensors include a perspiration sensor which measures a perspiration amount and a body temperature sensor which measures a body temperature, and
the portable terminal device comprises:
a mental state determination circuit that determines a mental state of an person subject to measurement based on the perspiration amount and reliability information of the perspiration amount and the body temperature and reliability information of the body temperature; and
a display circuit that displays the determined mental state.

7. The portable terminal device according to claim 6, further comprising:
a transmission circuit that transmits mental state information indicating the mental state determined by the mental state determination circuit to another terminal device.

8. (canceled)

9. (canceled)
